(19) United States
(12) Patent Application Publication
(10) Pub. No.: US 2026/0200660 A1
(43) Pub. Date: Jul. 16, 2026

(54) MATERIAL SPREADER AND AGITATOR SYSTEM AND METHOD

(71) Applicant: George A Palmer LTC, Charles Walters Equipment, New Lenox, IL (US)

(72) Inventors: Michael Palmer, Peckleton (GB); Marcus Palmer, Peckleton (GB); Bob Petrungaro, New Lenox, IL (US)

(21) Appl. No.: 19/018,011

(22) Filed: Jan. 13, 2025

(51) Int. Cl. B65D 83/06; B65D 25/52; B65D 47/06

(52) U.S. Cl. CPC B65D 83/06; B65D 25/52; B65D 47/06

(57) ABSTRACT

A material spreader includes a hopper that defines a hopper interior, a hopper exterior, and an opening that extends from the hopper exterior to the hopper interior. The material spreader also includes a shaft that extends through the opening, and a fastener that interfaces the hopper and the shaft at the opening, where the fastener supports and aligns the shaft on the hopper. The material spreader also includes a seal connected with the shaft and the fastener in the hopper interior, where the seal extends over the fastener, outward from the shaft toward an outer perimeter of the fastener.

### BACKGROUND

Material spreaders are widely used in agricultural, landscaping, and industrial applications to distribute granular materials, such as fertilizers, seeds, de-icing salts, and other particulate substances. These spreaders typically include a hopper to store the material, an agitator to ensure consistent flow of granules, and a discharge mechanism to distribute the material onto a target surface. Efficiency and reliability of material spreaders depend significantly on a smooth and uninterrupted flow of the granular material through the hopper and into the discharge mechanism.

To achieve consistent flow, agitators are commonly employed within the hopper to prevent bridging and clumping of the granular material. These agitators are generally mounted on driving shafts that extend through the walls of the hopper and are connected to external power sources such as electric motors or manual cranks. Known agitators often include rotating blades, paddles, or other mechanical configurations designed to agitate and dislodge granules that might otherwise form blockages.

Rotating agitators, while somewhat effective in promoting material flow, tend to create centrifugal forces that may segregate finer granules, leading to inconsistent material composition at the discharge point. Additionally, rotating agitators can cause excessive shear forces that may damage fragile granules, such as seeds or coated fertilizers, reducing their efficacy. These agitators also require high torque, precise alignment, and robust sealing at the shaft interfaces to prevent material ingress and mechanical wear, which increases an overall size of the material spreader, limits a storage capacity of the hoppers, and increases maintenance complexity.

A recurring issue with conventional material spreaders is the tendency of granular materials to clog interfaces between the driving shafts of the agitators and the hopper walls. Granules can become lodged in these interfaces due to gaps, uneven surfaces, or adhesive properties of certain materials. Such clogging not only impairs the rotation of the agitators but also increases wear on the driving shafts and associated seals, potentially leading to mechanical failure or a reduction in the overall lifespan of the spreader. In addition, the accumulation of granules at these interfaces can result in uneven distribution of material, compromising the effectiveness of the spreading operation.

### BRIEF DESCRIPTION

According to one aspect, a material spreader includes a hopper that defines a hopper interior, a hopper exterior, and an opening that extends from the hopper exterior to the hopper interior. The material spreader also includes a shaft that extends through the opening, and a fastener that interfaces the hopper and the shaft at the opening, where the fastener supports and aligns the shaft on the hopper. The material spreader also includes a seal connected with the shaft and the fastener in the hopper interior, where the seal extends over the fastener, outward from the shaft toward an outer perimeter of the fastener.

According to another aspect, a material spreader includes a hopper that defines a hopper interior, a hopper exterior, and an opening that extends from the hopper exterior to the hopper interior. The material spreader also includes a shaft that extends through the opening in a longitudinal direction, and a fastener that interfaces the hopper and the shaft at the opening, wherein the fastener supports and aligns the shaft on the hopper. The material spreader also includes a seal that extends over the fastener, outward from the shaft in a radial direction perpendicular to the longitudinal direction, toward an outer perimeter of the fastener.

According to another aspect, a material spreader includes a hopper, a shaft pivotally fixed with the hopper, and a cam fixed with the shaft. The material spreader also includes an agitator disposed in the hopper, where the shaft is operably connected to the agitator through the cam in the hopper interior such that rotating the shaft causes reciprocating motion in the agitator.

The innovation described herein describes a material spreader that offers reliable, and efficient material dispersal from a hopper. In addition to other described features, functions, and benefits, the material spreader encloses and shields moving parts from granular materials that may be stored in the hopper.

### BRIEF DESCRIPTION OF THE DRAWINGS

FIG. 1 is a front view of an example material spreader in accordance with aspects of the innovation.

FIG. 2 is a partial, enlarged, cross-sectional side view of the material spreader of FIG. 1, including a fastener sealed with a shaft.

FIG. 3 is a partial, enlarged, cross-sectional side view of the material spreader of FIG. 1, including a cam and an agitator engaged with the shaft.

FIG. 4 is a partial, enlarged, cross-sectional side view of a material spreader in accordance with aspects of the innovation, including a housing enclosing a shaft and a cam in a hopper.

### DETAILED DESCRIPTION

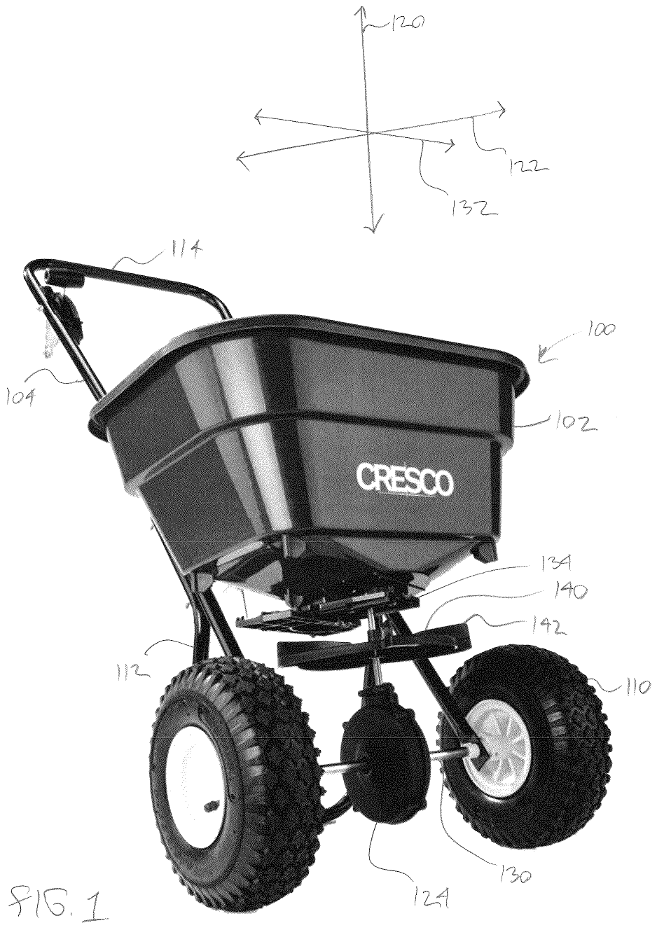

It should, of course, be understood that the description and drawings herein are merely illustrative and that various modifications and changes can be made in the structures disclosed without departing from spirit and scope of the present disclosure. Referring now to the drawings, wherein like numerals refer to like parts throughout the several views, FIG. 1 depicts a material spreader 100 including a hopper 102 supported on a frame 104 with a set of wheels 110 and a leg 112. The frame 104 forms a handle 114 above the hopper 102 in a top-bottom direction indicated by a first arrow 120. The frame 104 also forms the handle 114 behind the hopper 102 in a front-back direction perpendicular to the top-bottom direction, indicated by a second arrow 122. With this construction, the material spreader 100 is a walk-behind spreader or a push spreader that may be pushed or pulled by a user over a target area such as a lawn or field, where the material spreader 100 disperses granular material from the hopper 102.

The wheels 110 are operably connected to a mechanical drive 124 across an axel 130 such that pushing or pulling the material spreader 100 in the front-back direction at the handle 114 rotates the wheels 110 and the axel 130 about a left-right direction perpendicular to the top-bottom direction and the front-back direction, indicated by a third arrow 132. The mechanical drive 124 transfers rotational forces from the axel to a shaft 134, causing the shaft 134 to rotate about the top-bottom direction. While, as depicted, the mechanical drive 124 is a gear-driven mechanism, the mechanical drive 124 may additionally or alternatively include a chain and sprocket system or a variety of devices that rotate the shaft 134 with power from the axel 130 without departing from the scope of the subject disclosure.

The material spreader 100 includes an impeller 140 fixed with the shaft 134. The impeller 140 includes blades 142 extended radially outward from the shaft 134 in the front-back direction and the left-right direction. The blades 142 rotate with the shaft 134 about the top-bottom direction, and disperse granular material from the hopper 102 radially outward from the material spreader 100. In this manner, the shaft 134 is a cylindrical drive shaft that transfers torque from the wheels 110 to the impeller 140.

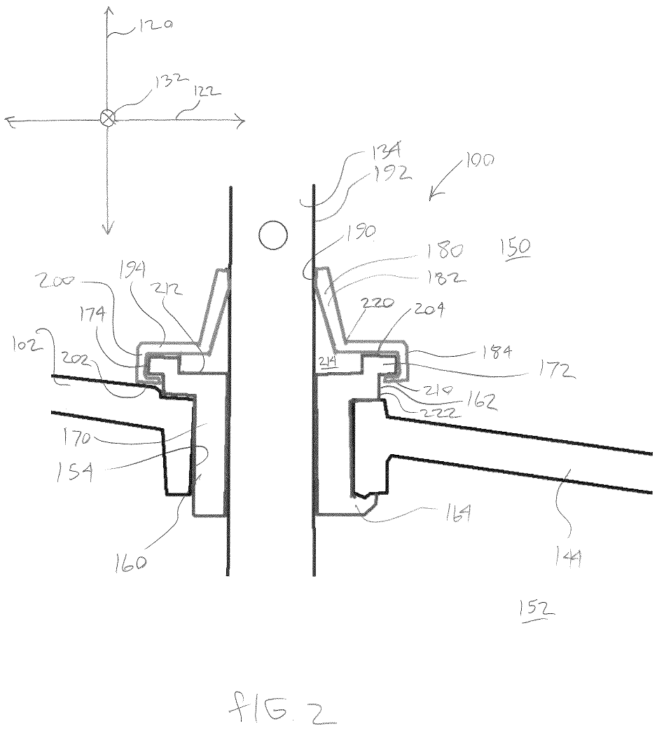

The shaft 134 extends from the mechanical drive 124, through the hopper 102 in the top-bottom direction. In this regard, as shown in FIG. 2, the hopper 102 is formed from a wall 144 that defines a hopper interior 150, a hopper exterior 152, and an opening 154 that extends from the hopper exterior 152 to the hopper interior 150. The shaft 134 extends from the axel 130 and through the opening 154 in a longitudinal direction of the shaft 134, into the hopper interior 150.

The material spreader 100 includes a fastener 160 that interfaces the hopper 102 and the shaft 134 at the opening 154. More specifically, the fastener 160 is a bushing that supports the shaft 134 on the hopper 102, and aligns the longitudinal direction of the shaft 134 with the top-bottom direction. When the hopper 102 is in an upright position the longitudinal direction of the shaft 134 is a vertical direction.

The fastener 160 includes a first flange 162 and a second flange 164 that extend radially outward from a main body portion 170, along the wall 144 forming the hopper 102 at the opening 154. The first flange 162 and the second flange 164 extend from opposite sides of the main body portion 170 in the top-bottom direction, and extend along opposite sides of the wall 144 in the top-bottom direction. With this construction, the first flange 162 extends along the wall 144 at the opening 154, in the hopper interior 150, and the second flange 164 extends along the wall 144 at the hopper exterior 152. In this manner, the first flange 162 and the second flange 164 obstruct movement of the fastener 160 in the longitudinal direction of the shaft 134.

The main body portion 170 forms a sleeve that extends around the shaft 134, and abuts the wall 144 at the opening 154. In this manner, the main body portion 170 obstructs movement of the fastener 160 and the shaft 134 in the left-right direction and the front-back direction relative to the hopper 102.

The main body portion 170 slides against the shaft 134. With this construction, the fastener 160 supports, fixes, and aligns the shaft 134 in a pivoting relationship with the hopper 102. While, as depicted, the fastener 160 is a bushing, the fastener 160 may additionally or alternatively include a bearing or various devices that support and align the shaft 134 on the hopper 102 without departing from the scope of the subject disclosure.

With continued reference to FIG. 2, the fastener 160 includes a lip 172 that extends outward from the main body portion 170 in a radial direction perpendicular to the longitudinal direction of the shaft 134. More specifically, the lip 172 is disposed on top of the first flange 162 in the top-bottom direction, and disposed along the first flange 162 in the front-back direction and the left-right direction. The lip 172 extends outward from the main body portion 170 and the first flange 162 in the radial direction, and defines an outer perimeter 174 of the fastener 160. The lip 172 also extends upward from the first flange 162, above the main body portion 170. With this construction, the outer perimeter 174 is an outermost face of the fastener 160, and located above the first flange 162 in the hopper interior 150.

The material spreader 100 includes a seal 180 connected with the shaft 134 and the fastener 160 in the hopper interior 150. The seal 180 extends over the fastener 160, outward from the shaft 134 in the radial direction, toward the outer perimeter 174 of the fastener 160.

The seal 180 includes an inclined portion 182 that directly contacts the shaft 134. The seal 180 also includes a rim 184 that extends outward beyond the lip 172, and hooks around the lip 172, including the outer perimeter 174 in the radial direction. In this regard, an inner surface 190 of the inclined portion 182 directly contacts an outer surface 192 of the shaft 134, and extends radially outward from the shaft with a downward incline. With this construction, granular material contained in the hopper 102 tends to fall off and away from the seal 180 and the fastener 160.

The seal 180 is elastic and configured to deform around the shaft 134 such that the inclined portion 182 stretches and forms a seal around the shaft 134. More specifically, the seal encloses the outer surface 192 of the shaft 134 in an interference fit, where the inclined portion 182 of the seal 180 stretches around and seals against the shaft 134. While, in the depicted embodiment, the seal 180 is formed from a synthetic rubber, the seal 180 may additionally or alternatively include natural rubber, foam rubber, sponge rubber, a thermoplastic elastomer, or a variety of elastic materials that may stretch around and seal against the shaft 134 without departing from the scope of the subject disclosure.

With continued reference to FIG. 2, the rim 184 includes a first rim portion 194, a second rim portion 200, and a third rim portion 202 integrally formed with each other in a hook shape that extends over and around the lip 172. In this regard, the first rim portion 194 extends straight outward in the radial direction from the inclined portion 182, along a top surface 204 of the lip 172. The second rim portion 200 extends straight downward from the first rim portion 194, along the outer perimeter 174.

A corner in the rim 184 formed between the first rim portion 194 and the second rim portion 200 is located at a corner in the lip 172 formed between the top surface 204 and the outer perimeter 174. With this construction, the first rim portion 194 and the second rim portion 200 extend continuously along the lip 172 between the top surface 204 and the outer perimeter 174.

The third rim portion 202 extends straight inward from the second rim portion 200 in the radial direction, along a bottom surface 210 of the lip 172. A corner in the rim 184 formed between the second rim portion 200 and the third rim portion 202 is located at a corner in the lip 172 formed between the outer perimeter 174 and the bottom surface 210. With this construction, the rim 184 extends continuously along and around outer surfaces of the lip, forming a seal between the seal 180 and the fastener 160. More specifically, the first rim portion 194, the second rim portion 200, and the third rim portion 202 continuously extend along and contact the lip 172 at the top surface 204, the outer perimeter 174, and the bottom surface 210.

As such, the seal 180 directly contacts and encloses the outer surface 192 of the shaft 134 and a top end 212 of the fastener 160 from the hopper interior 150. The top end 212 of the fastener 160 includes the lip 172 at the outer perimeter 174, and portions of the fastener 160 that define the unitary cavity 214, including the main body portion 170 and the first flange 162. In this regard, the inclined portion 182 and the rim 184 extend directly from the outer surface 192 of the shaft 134 to the outer perimeter 174, and around the lip 172 of the fastener 160.

With continued reference to FIG. 2, the seal 180 extends directly over the fastener 160, in the top-bottom direction, from the outer surface 192 of the shaft 134 to the outer perimeter 174 of the fastener 160. With this construction, the shaft 134, the fastener 160, and the seal 180 define a unitary cavity 214 around the shaft 134. The outer surface 192 of the shaft 134 and inclined portion 182 of the seal 180 define the unitary cavity 214 in the radial direction, which is any combination of the left-right direction and the front-back direction outward from the shaft 134. The top end 212 of the fastener 160 and the seal 180, including the inclined portion 182 and the rim 184, define the unitary cavity 214 in the top-bottom direction.

The seal 180 forms a bend 220 between the inclined portion 182 and the rim 184. The bend 220 is a structural irregularity in the seal 180 that deforms when the shaft 134 slides in the longitudinal direction relative to the fastener 160. More specifically, when the shaft 134 slides in the longitudinal direction, the inclined portion 182 and the rim 184 maintain the respective seal interfaces with the outer surface 192 of the shaft 134 and the lip 172 of the fastener 160. As such, the inclined portion 182 moves in the longitudinal direction with the shaft 134 while the rim 184 remains stationary with the fastener 160, causing the seal 180 to deform at the bend 220.

The inclined portion 182 and the rim 184 extend directly over the unitary cavity 214 in the top-bottom direction. As such, then the shaft 134 slides downward in the longitudinal direction, the seal 180 may deform at the bend 220, into the unitary cavity 214. In this manner, the unitary cavity 214 may receive and accommodate the seal 180, avoiding circumstances where the seal 180 becomes caught between the outer surface 192 of the shaft 134 and the main body portion 170 of the fastener 160.

The shaft 134, the seal 180, the fastener 160, and the wall 144 form a continuous interior containment surface 222 that defines the hopper interior 150. The interior containment surface 222 is impervious to granular material, such that the hopper 102 is configured to store granular material in the hopper interior 150, against the interior containment surface 222. The seal 180 is sealed against the shaft 134 and the fastener 160, and the fastener 160 is sealed against the seal 180 and the wall 144 at the opening 154. As such, the seal 180 and the fastener 160 define the interior containment surface 222 from the shaft 134 to the hopper 102.

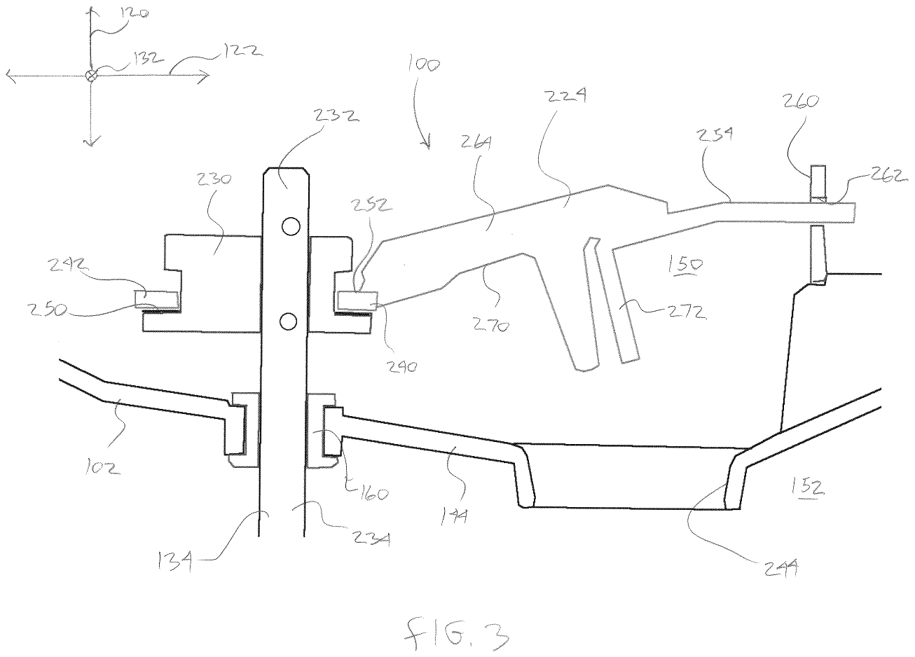

As shown in FIG. 3, the shaft 134 is a camshaft operably connected to an agitator 224 through a cam 230, above the seal 180 in the hopper interior 150 such that rotating the shaft causes reciprocating motion in the agitator 224. In this regard, the shaft 134 includes a first end portion 232 engaged with the agitator 224 in the hopper interior 150, above the seal 180 in the top-bottom direction. The first end portion 232 extends upward from the opening 154 in the longitudinal direction.

The shaft 134 also includes a second end portion 234 extended downward from the first end portion 232, below the opening 154 in the longitudinal direction. The impeller 140 is fixed with the second end portion 234, and the cam 230 is fixed with the first end portion 232 such that rotating the shaft 134 rotates the cam 230 at the first end portion 232, and rotates the impeller 140 at the second end portion 234. The impeller 140 is engaged with the second end portion 234 of the shaft 134 directly below the opening 154 such that rotating the shaft 134 rotates the cam 230 at the first end portion 232, and rotates the impeller 140 at the second end portion 234.

The shaft 134 is operably connected to the agitator through the cam 230 such that rotating the shaft 134 about the longitudinal direction causes the agitator 224 to linearly reciprocate in the radial direction. In this regard, the cam 230 is a disk cam that extends straight outward from the shaft 134 in the radial direction. While, as depicted, the cam 230 is an eccentric cam offset from the shaft 134 and formed with a circular shape in the radial direction, the cam 230 may additionally or alternatively take a variety of shapes and mounting positions on the shaft 134. As such, the cam 230 may be a heart or constant velocity cam, or a pear cam, and mounted centered on the shaft 134 without departing from the scope of the subject disclosure.

The agitator 224 includes a first follower 240 and a second follower 242 engaged with the cam 230 such that rotating the shaft causes the cam 230 to push the agitator forward or backward along the reciprocating motion at the first follower 240 and the second follower 242. More specifically, the first follower 240 is engaged with the cam 230 at a side of the cam 230 in the front-back direction, and pushes the agitator 224 forward in the reciprocating motion when the shaft 134 and the cam 230 rotate about the longitudinal direction. The second follower 242 is engaged with the cam 230 at a side of the cam 230 opposite the first follower 240 in the front-back direction, and pushes the agitator 224 backward in the reciprocating motion when the shaft 134 and the cam 230 rotate about the longitudinal direction. In this manner, the cam 230 pushes the agitator 224 forward or backward in linear reciprocating motion at the first follower 240 and the second follower 242. While, as depicted, the cam 230, the first follower 242, and the second follower 244 form a cam mechanism that transfers rotational motion from the shaft 134 to reciprocating motion in the agitator 224, the material spreader 100 may additionally or alternatively include a variety of devices for converting the rotational motion from the shaft 134 to the reciprocating motion in the agitator 224, such as a crank and slider mechanism, a scotch yoke mechanism, a Geneva drive, a ratchet mechanism, a rack and pinion mechanism, or a quick return mechanism.

While, as depicted, the first follower 240 and the second follower 242 are flat followers that remain stationary relative to the cam 230 and slide along the cam 230 as the shaft 134 and the cam 230 rotate about the longitudinal direction, the first follower 240 or the second follower 242 may additionally or alternatively include rolling or rounded surfaces that contact the cam 230 and push the agitator 224 in the reciprocating motion without departing from the scope of the subject disclosure.

With continued reference to FIG. 3, the wall 144 defines an aperture 244 that disperses granular material from the hopper interior 150 to the hopper exterior 152. The agitator 224 is disposed in the hopper interior 150, directly above the aperture 244 in the top-bottom direction, and extended across the aperture 244 in the front-back direction. The blades 142 of the impeller 140 extend directly below the aperture 244 in the top-bottom direction, and across the aperture 244 from the shaft 134 in the front-back direction. With this construction, when the hopper 102 contains a granular material in the hopper interior 150, and the shaft 134 rotates about the longitudinal direction, the shaft 134 drives the agitator and causes the granular material to flow out of the hopper interior 150 through the aperture 244 and onto the impeller 140. Rotating the shaft 134 about the longitudinal direction also drives the impeller 140 to disperse the granular material from the blades 142.

The cam 230 supports the agitator 224 in the hopper 102, in the longitudinal direction. In this regard, the cam 230 forms a seat 250 that obstructs movement of the first follower 240 and the second follower 242 downward in the top-bottom direction. As such, the first follower 240 and the second follower 242 form a proximal end portion 252 of the agitator 224 directly supported in the hopper 102.

The agitator 224 includes a distal end portion 254 directly supported in the hopper 102 at a side of the aperture 244 opposite the proximal end portion 252 in the radial direction. The distal end portion 254 is a rod extended straight forward in the radial direction from the proximal end portion 252, parallel to the linear reciprocating motion of the agitator 224.

With continued reference to FIG. 3, the material spreader 100 includes a bracket 260 fixed with the wall 144. The bracket 260 extends upward from the wall 144 in the top-bottom direction, and defines a slot 262 that receives and supports the distal end portion 254. The distal end portion 254 extends into the slot, parallel to the direction of the reciprocating motion by the agitator 224, and a length of the distal end portion 254 is at least as long as a full single stroke length of the agitator 224.

The bracket 260 directly supports and retains the distal end portion 254 of the agitator 224 in a sliding relationship with the hopper 102 at the slot 262. With this construction, the bracket 260 guides movement of the distal end portion 254 at the slot 262 to follow the reciprocating motion driven at the proximal end portion 252. As such, the linear reciprocating motion of the agitator 224 at the proximal end portion 252 causes the distal end portion 254 to follow the linear reciprocating motion, where the distal end portion 254 slides back and forth, or reciprocates, through the slot 262.

The agitator 224 also includes an intermediate portion 264 that connects the proximal end portion 252 and the distal end portion 254 across the aperture 244 in the radial direction. The proximal end portion 252 and the distal end portion 254 are directly supported in the hopper 102 at different locations in the longitudinal direction, and the intermediate portion 264 extends between the proximal end portion 252 and the distal end portion 254 in the longitudinal direction.

More specifically, the slot 262 supports the distal end portion 254 above the proximal end portion 252 at the seat 250. The intermediate portion 264 extends straight between the proximal end portion 252 and the distal end portion 254 in the longitudinal direction. With this construction, the intermediate portion 264 is inclined upward from the proximal end portion 252 to the distal end portion 254 in the longitudinal direction, where a bottom side 270 of the intermediate portion 264 faces the aperture 244.

The agitator 224 includes legs 272 extended perpendicular from the intermediate portion 264 at the bottom side 270. As such, the legs 272 extend toward the aperture 244 from the bottom side 270 in the radial direction and the longitudinal direction. The legs 272 are fixed with the intermediate portion 264 between the proximal end portion 252 and the distal end portion 254, such that rotating the shaft 134 causes the legs 272 to reciprocate in the hopper interior 150 with the proximal end portion 252, the intermediate portion 264, and the distal end portion 254. In this manner, the agitator 224 prevents bridging, clumping, or obstruction of granular material in the hopper interior 150.

With the intermediate portion 264 inclined upward from the proximal end portion 252 to the distal end portion 254, a longitudinal distance the shaft 134 extends into the hopper interior 150 may be reduced, increasing an overall storage capacity of the hopper 102. Furthermore, the incline of the intermediate portion 264 at the bottom side 270 leverages the extended direction of the legs 272 toward the aperture 244 in the direction of the reciprocating motion. This construction of the agitator 224 in the hopper 102 increases a structural reliability in the intermediate portion 264 and the legs 272 for moving through granular material, thereby reducing an overall size requirement of the agitator 224 and increasing an overall storage capacity of the hopper 102.

The agitator 224 is a unitary body formed from a continuous material, such as injection molded plastic or pressed metal sheeting. With this construction, the first follower 240, the second follower 242, the proximal end portion 252, the intermediate portion 264, the legs 272, and the distal end portion 254 are integrally formed and rigidly fixed with each other.

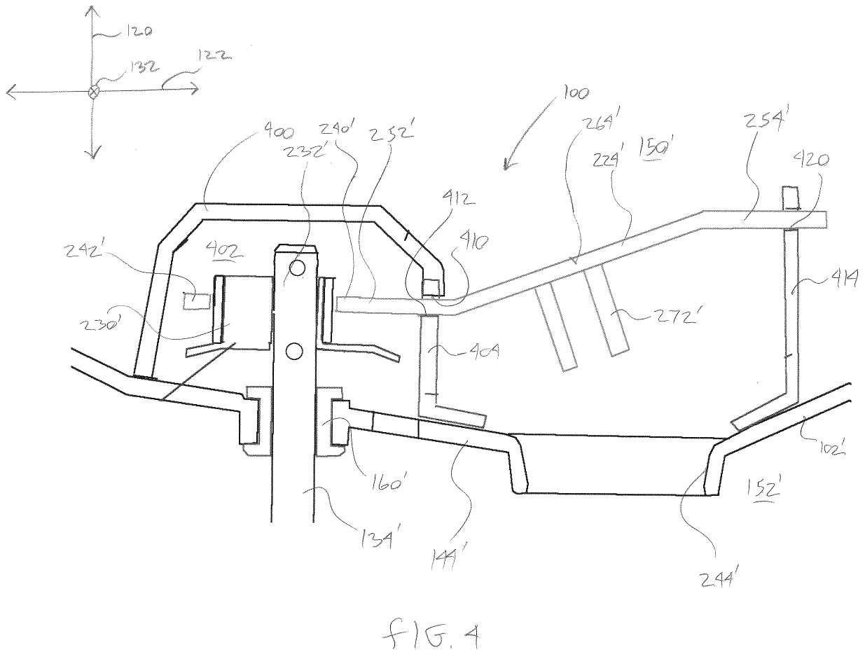

FIG. 4 illustrates an alternate embodiment of the material spreader 100 of FIGS. 1-3. In the embodiment of FIG. 4, like elements with the material spreader 100 of FIGS. 1-3 are denoted with the same reference numerals but followed by a primed suffix (′). FIG. 4 illustrates an embodiment of the material spreader 100 including a housing 400 that encloses the shaft 134′ and the cam 230′ in the hopper 102′, sealing the shaft 134′ and the cam 230′ from granular material that may be contained in the hopper interior 150′.

More specifically, the housing 400 is fixed to the wall 144′, where the hopper 102′ and the housing 400 define a chamber 402 that contains the shaft 134′ and the cam 230′. The chamber 402 encloses the shaft 134′ and the cam 230′ in the hopper interior 150′ where the cam 230′ engages the proximal end portion 252′ of the agitator 224′.

The material spreader 100 includes a first bracket 404 fixed with the wall 144′ and the housing 400, where the first bracket 404 defines the chamber 402. In this regard, the housing 400 defines a channel 410 that receives the proximal end portion 252′ of the agitator 224′ engaged with the cam 230′. The first bracket 404 extends upward along the channel 410, from the wall 144′ in the top-bottom direction. As such, the first bracket 404 closes the channel 410 and defines the chamber 402 with the housing 400 and the wall 144′, around the shaft 134′ and the cam 230′. With this construction, the housing 400, the first bracket 404, and the wall 144′ shield the shaft 134′, the cam 230′, and the proximal end portion 252′ of the agitator 224′ from granular material in the hopper interior 150′.

With continued reference to FIG. 4, the first bracket 404 defines a first slot 412 that receives and supports the proximal end portion 252′ of the agitator 224′. The proximal end portion 252′ is a rod that extends into the first slot 412 from the intermediate portion 264′, parallel to the direction of the reciprocating motion. A length of the proximal end portion 252′ is at least as long as a full single stroke length of the agitator 224′.

In this manner, the first bracket 404 directly supports and retains the distal end portion 254′ of the agitator 224′ in a sliding relationship with the hopper 102′ at the first slot 412. With this construction, the first bracket 404 guides movement of the proximal end portion 252′ at the first slot 412 to follow the linear reciprocating motion driven by the cam 230′.

The first bracket 404 is fixed with the hopper 102′ in front of the aperture 244′ with respect to the cam 230′. The material spreader 100 also includes a second bracket 414 fixed with the hopper 102′ behind the aperture 244′ with respect to the cam 230′, where the second bracket 414 supports the distal end portion 254′ in a second slot 420. As such, the first bracket 404 and the second bracket 414 support the agitator 224′ directly over the aperture 244′ a the first slot 412 and the second slot 420 in the top-bottom direction, and across the aperture 244′ in the front-back direction from opposite sides of the aperture 244′. In this regard, the first bracket 404 and the second bracket 414, including the first slot 412 and the second slot 420, include similar features and function in a similar manner for directly supporting the agitator 224′ in a sliding relationship with the hopper 102′ over and across the aperture 244′.

The proximal end portion 252′ and the distal end portion 254′ extend straight outward from the intermediate portion 264′ in the radial direction, where the first bracket 404 and the second bracket 414 directly support the proximal end portion 252′ and the distal end portion 254′ in the hopper 102′. The intermediate portion 264′ extends between the first bracket 404 and the second bracket 414, and includes the legs 272′ rigidly fixed with the intermediate portion 264′ and extended downward from the intermediate portion 264′, toward the aperture 244′ in the hopper interior 150′.

While, as depicted, the material spreader 100 is a walk-behind spreader that may be pushed or pulled by a user over a target area, the material spreader 100 may additionally or alternatively include a variety of devices for transporting the hopper 102 and driving the shaft 134 without departing from the scope of the subject disclosure. In this regard, the material spreader 100 may alternatively be mounted or operably connected to a powered vehicle operated by a user for dispersing contents from the hopper 102. Furthermore, the material spreader 100 may additionally or alternatively include powered devices for driving the shaft 134 and actuating the impeller 140 and the agitator 224.

While specific embodiments are shown and described herein, it is contemplated that alternative embodiments exist that employ alternative materials, mixtures, proportions, sizes, etc. without departing from the spirit and/or scope of the innovation as described in detail. These alternative embodiments are to be included within the spirit and scope of the innovation as described and claimed herein.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited thereto.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A material spreader comprising:
a hopper that defines a hopper interior, a hopper exterior, and an opening that extends from the hopper exterior to the hopper interior;
a shaft that extends through the opening;
a fastener that interfaces the hopper and the shaft at the opening, wherein the fastener supports and aligns the shaft on the hopper; and
a seal connected with the shaft and the fastener in the hopper interior, wherein the seal extends over the fastener, outward from the shaft toward an outer perimeter of the fastener.

2. The material spreader of claim 1, wherein the shaft extends in a longitudinal direction, the fastener includes a lip that extends outward from a main body portion in a radial direction perpendicular to the longitudinal direction, and the seal extends outward from the shaft, along a top surface of the lip in the radial direction.

3. The material spreader of claim 2, wherein the seal extends downward, along the outer perimeter.

4. The material spreader of claim 3, wherein the seal extends inward from the outer perimeter, along a bottom surface of the lip.

5. The material spreader of claim 4, wherein the seal continuously extends along and contacts the top surface, the outer perimeter, and the bottom surface of the lip.

6. The material spreader of claim 2, wherein the fastener includes a flange extended from the main body portion, along the hopper in the hopper interior, and the lip extends outward from the flange in the radial direction.

7. The material spreader of claim 1, wherein the seal is formed from natural rubber, synthetic rubber, or a thermoplastic elastomer.

8. The material spreader claim 1, wherein the seal directly contacts and encloses an outer surface of the shaft in the hopper interior, and extends from the outer surface of the shaft to the outer perimeter of the fastener.

9. The material spreader of claim 1, wherein the seal includes an inclined portion that directly contacts an outer surface of the shaft, and extends radially outward from the shaft with a downward incline.

10. The material spreader of claim 1, wherein the seal extends directly over the fastener from the shaft to the outer perimeter, wherein the shaft, the fastener, and the seal define a unitary cavity around the shaft.

11. The material spreader of claim 1, wherein the shaft is a camshaft operably connected to an agitator, or a drive shaft operably connected to an impeller, and
the fastener is a bushing or a bearing that supports and aligns the shaft in a pivoting relationship with the hopper.

12. The material spreader of claim 1, wherein the seal and the fastener define an interior containment surface that defines the hopper interior, from the shaft to the hopper.

13. The material spreader of claim 12, wherein the shaft is operably connected to an agitator through a cam in the hopper interior, above the seal.

14. A material spreader comprising:
a hopper that defines a hopper interior, a hopper exterior, and an opening that extends from the hopper exterior to the hopper interior;
a shaft that extends through the opening in a longitudinal direction;
a fastener that interfaces the hopper and the shaft at the opening, wherein the fastener supports and aligns the shaft on the hopper; and
a seal that extends over the fastener, outward from the shaft in a radial direction perpendicular to the longitudinal direction, toward an outer perimeter of the fastener.

15. The material spreader of claim 14, wherein the fastener includes a lip that extends outward from the shaft in the radial direction,
the lip defines the outer perimeter of the fastener, and
the seal extends outward from the shaft, beyond the lip in the radial direction.

16. The material spreader of claim 14, wherein the fastener includes a flange that extends along the hopper at the opening, in the hopper interior, and
the seal encloses a top end of the fastener and an outer surface of the shaft from the hopper interior.

17. The material spreader of claim 14, wherein the shaft is cylindrical, the seal is elastic, and the seal encloses an outer surface of the shaft in an interference fit where the seal stretches around the shaft.

18. The material spreader of claim 14, wherein the seal extends directly over the fastener from the shaft to the outer perimeter such that the shaft, the fastener, and the seal define a unitary cavity, and
the seal includes an inclined portion that directly contacts an outer surface of the shaft, and extends radially outward from the shaft with a downward incline.

19. The material spreader of claim 18, wherein the fastener includes a main body portion and a lip that extends upward above the main body portion,
the lip and the outer surface of the shaft define the unitary cavity in the radial direction, and
the main body portion and the seal define the unitary cavity in the longitudinal direction.

20. The material spreader of claim 14, wherein the shaft is a camshaft operably connected to an agitator through a cam in the hopper interior, above the seal, and
the fastener is a bushing or a bearing that supports and aligns the shaft in a pivoting relationship with the hopper.

21. A material spreader comprising:
a hopper;
a shaft pivotally fixed with the hopper;
a cam fixed with the shaft; and
an agitator disposed in the hopper, wherein the shaft is operably connected to the agitator through the cam in the hopper interior such that rotating the shaft causes reciprocating motion in the agitator.

22. The material spreader of claim 21, wherein rotating the shaft causes linear reciprocating motion in the agitator.

23. The material spreader of claim 21, further comprising at least one bracket fixed with the hopper, wherein the at least one bracket defines a slot that supports the agitator in the hopper, and rotating the shaft causes the agitator to reciprocate through the slot.

24. The material spreader of claim 23, wherein the reciprocating motion in the agitator is linear, the agitator includes a rod extended into the slot, parallel to a direction of the reciprocating motion, and a length of the rod in the direction of the reciprocating motion is at least as long as a full single stroke length of the agitator.

25. The material spreader of claim 21, wherein the hopper defines a hopper interior, a hopper exterior, and an aperture that extends from the hopper exterior to the hopper interior, and the material spreader further comprises:
a first bracket fixed with the hopper in front of the aperture with respect to the cam; and
a second bracket fixed with the hopper behind the aperture with respect to the cam, wherein the first bracket and the second bracket support the agitator directly over the aperture.

26. The material spreader of claim 25, wherein the agitator includes an intermediate portion extended between the first bracket and the second bracket, and includes a leg rigidly fixed with the intermediate portion and extended downward from the intermediate portion, toward the aperture in the hopper interior.

27. The material spreader of claim 21, wherein the hopper defines a hopper interior, the shaft extends into the hopper interior in a longitudinal direction, the shaft is operably connected to the agitator through the cam such that rotating the shaft causes linear reciprocating motion in the agitator, in a radial direction perpendicular to the longitudinal direction.

28. The material spreader of claim 21, further comprising a housing that encloses the shaft and the cam in the hopper, and defines a channel that receives a proximal end portion of the agitator engaged with the cam.

29. The material spreader of claim 28, wherein the hopper and the housing define a chamber that contains the shaft and the cam.

30. The material spreader of claim 21, wherein the agitator includes a follower engaged with the cam, wherein rotating the shaft causes the cam to push the agitator forward or backward along the reciprocating motion at the follower.

31. The material spreader of claim 30, wherein the follower forms a proximal end portion of the agitator, the agitator includes a distal end portion extended from the proximal end portion, and the proximal end portion is integrally formed with the distal end portion.

32. The material spreader of claim 30, wherein the follower is a flat follower that slides along the cam when the shaft rotates.

33. The material spreader of claim 21, wherein the agitator includes a first follower that is engaged with the cam and pushes the agitator forward in the reciprocating motion when the shaft rotates, and
the agitator includes a second follower that is engaged with the cam at a side of the cam opposite the first follower, and pushes the agitator backward in the reciprocating motion when the shaft rotates.

34. The material spreader of claim 21, wherein the shaft extends in a longitudinal direction,
the cam causes the agitator to reciprocate in a radial direction perpendicular to the longitudinal direction,
the hopper defines an aperture;
the agitator includes a proximal end portion directly supported in the hopper,
the agitator includes a distal end portion directly supported in the hopper at a side of the aperture opposite the proximal end portion in the radial direction, and
the proximal end portion and the distal end portion are directly supported in the hopper at different locations in the longitudinal direction.

35. The material spreader of claim 34, wherein when the hopper is in an upright position the longitudinal direction is a vertical direction,
the distal end portion is supported above the proximal end portion in the longitudinal direction, and
the proximal end portion or the distal end portion extend straight in the radial direction where the proximal end portion or the distal end portion are directly supported in the hopper.

36. The material spreader of claim 34, wherein the agitator includes an intermediate portion that connects the proximal end portion and the distal end portion across the aperture in the radial direction, and the intermediate portion extends between the proximal end portion and the distal end portion in the longitudinal direction.

37. The material spreader of claim 36, wherein the intermediate portion extends straight between the proximal end portion and the distal end portion, and is inclined from the proximal end portion toward the distal end portion in the longitudinal direction.

38. The material spreader of claim 37, wherein the agitator includes a leg extended from the intermediate portion, toward the aperture in the radial direction and the longitudinal direction, and
the proximal end portion, the intermediate portion, the leg, and the distal end portion are integrally formed with each other.

39. The material spreader of claim 21, wherein the shaft extends in a longitudinal direction, the cam reciprocates the agitator in a radial direction perpendicular to the longitudinal direction, and the cam supports the agitator in the hopper, in the longitudinal direction.

40. The material spreader of claim 21, wherein the hopper that defines a hopper interior, a hopper exterior, and an opening that extends from the hopper exterior to the hopper interior,
the shaft extends through the opening,
the shaft includes a first end portion engaged with the agitator in the hopper interior,
the shaft includes a second end portion extended from the first end portion, and
the material spreader further comprises an impeller that is engaged with the second end portion of the shaft directly below the opening, such that rotating the shaft rotates the cam at the first end portion, and rotates the impeller at the second end portion.
